(19) United States
(12) Patent Application Publication
(10) Pub. No.: US 2013/0038901 A1
(43) Pub. Date: Feb. 14, 2013

(54) FACSIMILE APPARATUS

(71) Applicants: Koji SHIMADU, Inazawa-shi (JP); Susumu CHIDA, Ichinomiya-shi (JP)

(72) Inventors: Koji SHIMADU, Inazawa-shi (JP); Susumu CHIDA, Ichinomiya-shi (JP)

(73) Assignee: BROTHER KOGYO KABUSHIKI KAISHA, Nagoya-shi (JP)

(21) Appl. No.: 13/422,853

(22) Filed: Mar. 16, 2012

(30) Foreign Application Priority Data
Aug. 9, 2011 (JP) 2011-173696

(51) Int. Cl. G06F 15/00

(52) U.S. Cl. 358/1.15

(57) ABSTRACT

There is provided a facsimile apparatus which includes a scanning section, an operating section which inputs a facsimile number, a first communication section which is connected to a communication line, a first communication control section which controls the first communication section, a first storage section in which information of the remote apparatus has been stored, a first judgment section which judges whether or not information of the remote apparatus corresponding to a first facsimile number is stored in the first storage section, a re-input section which inputs a second facsimile number when the information of the remote apparatus is stored in the first storage section. When the first judging section judges that the information of the remote apparatus is stored in the first storage section, or when the first facsimile number and the second facsimile number are same, the facsimile apparatus transmits facsimile data to the remote apparatus.

### CROSS REFERENCE TO RELATED APPLICATION

The present application claims priority from Japanese Patent Application No. 2011-173696, filed on Aug. 9, 2011, the disclosure of which is incorporated herein by reference in its entirety.

### BACKGROUND OF THE INVENTION

1. Field of the Invention

The present invention relates to a facsimile apparatus which favorably prevents a wrong transmission.

2. Description of the Related Art

Technologies related to a facsimile apparatus have hitherto been proposed. For instance, in Japanese Patent Application Laid-open Publication No. 2010-288102, a facsimile apparatus having the following feature is disclosed. That is, when a FAX number of a destination has been input for the first time, a FAX transmission record in the past, that is a FAX transmission history, is checked. When a transmission record of a FAX transmission to the same FAX number during a preset period of time is remained, it is assumed that an accuracy of the FAX number which has been input for first time has been confirmed, and facsimile transmission starts. In this facsimile apparatus, when the FAX number which is input for the first time is not found in the transmission record does not match, a facsimile transmission processing is terminated.

Japanese patent Application Laid-open Publication No. 2008-98775 discloses a multifunction device which is connected to a network and is configured to use a corporate telephone directory database. In this multifunction device, the corporate telephone directory data base is retrieved by using a number which is input by a user as a retrieval key, and verifies if the matching number has been stored in the corporate telephone directory database. In a case in which the matching number has been stored, the corporate name associated with the number is displayed on a display section. When the user gives an instruction for facsimile transmission, the number is dialed and facsimile transmission is carried out. In a case of a matching discrepancy, when the destination is an individual, the facsimile transmission is carried out upon verification by the user. When the destination is a corporation, a number similar to the input FAX number is extracted from the corporate telephone directory database, and the extracted FAX number and the corporate name thereof are displayed on the display section.

### SUMMARY OF THE INVENTION

In a case of carrying out the facsimile transmission, it is desirable that the facsimile transmission is carried out by a smooth operation without any trouble while preventing a situation in which the facsimile data is transmitted to a wrong facsimile apparatus as a remote apparatus.

An object of the present teaching is to provide a facsimile apparatus which enables to carry out favorably an operation for facsimile transmission upon preventing a mistransmission due to a misdialing of facsimile number.

According to an aspect of the present teaching, there is provided a facsimile apparatus which transmits facsimile data corresponding to a document to a remote apparatus via a communication line, including:

a scanning section which scans the document to generate the facsimile data;

an operating section through which a facsimile number of the remote apparatus is input;

a first communication section connected to the communication line;

a first communication control section which controls the first communication section;

a first storage section in which information of the remote apparatus corresponding to a facsimile number for a past facsimile transmission carried out by the facsimile apparatus, is stored;

a first judging section which judges whether or not information of the remote apparatus corresponding to a first facsimile number has been stored in the first storage section, under a condition that the first facsimile number is newly input via the operating section; and

a re-input section which controls the operating section to acquire once again the facsimile number of the remote apparatus to which the facsimile data is to be transmitted, as a second facsimile number, under a condition that the first judging section judges that the information of the remote apparatus corresponding to the first facsimile number is not stored in the first storage section,

wherein the first communication control section controls the first communication section to transmit the facsimile data to the remote apparatus of the first facsimile number, under a condition that the first judging section judges that the information of the remote apparatus corresponding to the first facsimile number is stored in the first storage section, and

the first communication control section controls the first communication section to transmit the facsimile data to the remote apparatus of the second facsimile number, under a condition that the second facsimile number is same as the first facsimile number.

Accordingly, in a case in which the information of the remote apparatus corresponding to the first facsimile number which is input for a facsimile transmission has not been stored in the first storage section, it is possible to carry out re-input of the facsimile number. Therefore, it is possible to verify if the number is input wrongly, before the facsimile transmission. Besides, when the second facsimile number which is re-input is same as the first facsimile number, it is possible to carry out facsimile transmission. In the case in which the information of the remote apparatus corresponding to the first facsimile number has been stored in the first storage section, the facsimile transmission is possible without having a need to carry out any other operation. In this case, ‘information of the remote apparatus corresponding to the facsimile number’, apart from information indicating a facsimile number matching with the facsimile number, includes a name of the remote apparatus of the facsimile number. In the expression “in a case in which, the second facsimile number matches with the first facsimile number, the facsimile data is transmitted to the remote apparatus of the second facsimile number”, the facsimile number is same as the first facsimile number. Consequently, in this case, the remote apparatus of the second facsimile number is same as the remote apparatus of the first facsimile number, and is the present teaching includes this concept. Regarding the judgment of the first judging section, the expression that “the transmission result which indicates the success of the facsimile transmission is not stored in the first storage section upon associating with the information of the remote apparatus corresponding to the first facsimile number” includes the meaning that a transmission result which does not indicate the success of the facsimile transmission is stored in the first storage section upon associating with the information of the remote apparatus corresponding to the first facsimile number.

### BRIEF DESCRIPTION OF THE DRAWINGS

FIG. 1 is a block diagram showing an example of a configuration of a facsimile apparatus;

FIG. 2 is a diagram showing an example of a communication record table of main-body side;

FIG. 3 is a part of a flowchart of a FAX transmission processing;

FIG. 4 is a part of a flowchart of the FAX transmission processing;

FIG. 5 is a flowchart of a main-body reference processing;

FIG. 6 is a flowchart of external reference processing;

FIG. 7 is a diagram showing an example of a communication record table of external side; and

FIG. 8 is a flowchart of an external recording process;

### DESCRIPTION OF THE PREFERRED EMBODIMENTS

An exemplary embodiment of the present teaching will be described below by using the accompanying diagrams. However, the present teaching is not restricted to embodiment described below, and it is possible to adopt various modifications with the same technical idea. For instance, a part of the structures shown below may be omitted or may be replaced by another structure. Moreover, other structures may also be included.

<Facsimile Apparatus>

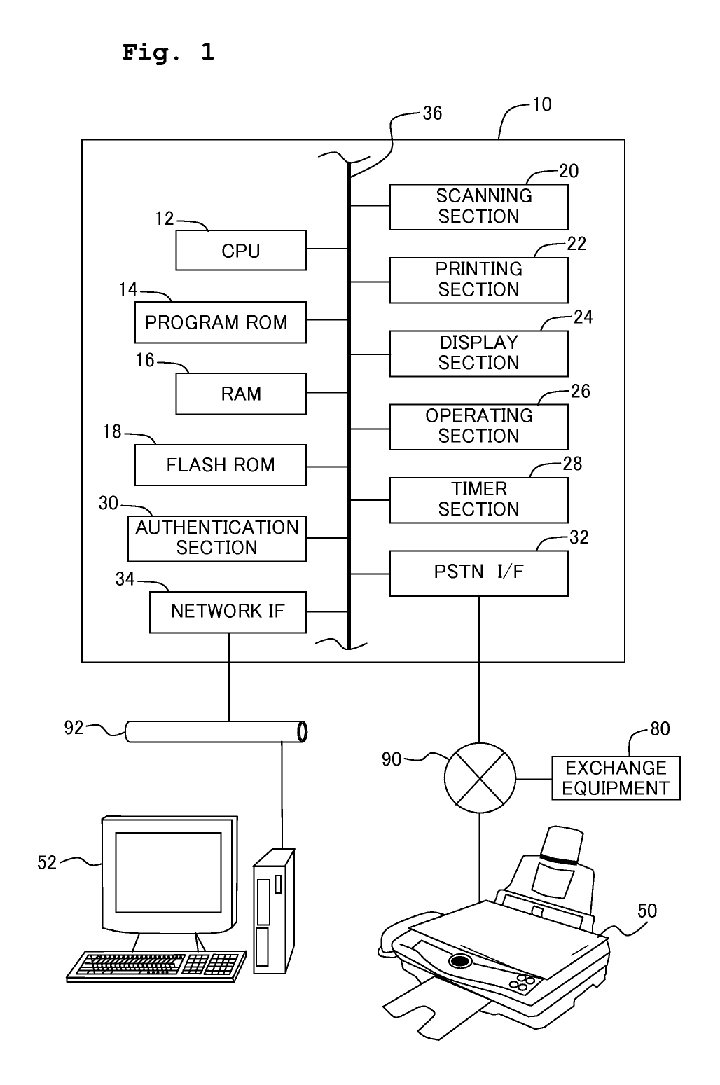

A facsimile apparatus 10 (hereinafter, called as ‘FAX apparatus 10’) will be described below by referring to FIG. 1. The FAX apparatus 10 is to be connected to a communication line for carrying out facsimile communication (hereinafter, called as ‘FAX communication’). The communication line is a PSTN 90, that is short for Public Switched Telephone Network, which includes a telephone exchange 80. Besides this, an NGN that is short for Next Generation Network which enables high-speed communication has been put to practical use. In this embodiment, the FAX apparatus 10 is connected to the PSTN 90, and carries out FAX communication with another FAX apparatus 50 (hereinafter, called as ‘remote apparatus 50’). For example, image data corresponding to a document which has been read out by the FAX apparatus 10 is encoded to facsimile data (hereinafter, called as ‘FAX data’), and the FAX data is facsimile transmitted (hereinafter, called as ‘FAX transmission’) to the remote apparatus 50. The FAX apparatus 10 receives FAX data transmitted from the remote apparatus 50, and prints an image corresponding to the received FAX data on a recording paper. The remote FAX apparatus 50 may be a conventional FAX apparatus, or may be an apparatus same as the FAX apparatus 10. Description related to the remote apparatus 50 will be omitted here.

The FAX apparatus 10 is also connected to a communication network different from the PSTN 90. As the communication network different from the PSTN 90, a LAN 92, that is short for Local Area Network, is exemplified. The LAN 92 may be a wired or a wireless network. The FAX apparatus 10 carries out data communication with an external apparatus 52 which is connected to the LAN 92. A server unit, a personal computer or an external storage unit such as an external hard disc is exemplified as the external apparatus 52. The communication network is construed widely. The FAX apparatus 10 and the external apparatus 52 may be connected by USB. The external apparatus 52 is an apparatus as mentioned above, and is similar to apparatuses which are in widespread use, except for a point that the external apparatus 52 stores a communication record external table which will be described later. Therefore, description related to the external apparatus 52 will be omitted. The communication record external table will be described later.

The FAX apparatus 10, as shown in FIG. 1, includes mainly a CPU 12, a program ROM 14, a RAM 16, a flash RAM 18, a scanning section 20, a printing section 22, a display section 24, an operating section 26, a timer section 28, an authentication section 30, a PSTN I/F 32, and a network I/F 34. Each of the components denoted by reference numerals 12 to 34 are connected to a bus line 36. The CPU 12 carries out an arithmetic processing. The program ROM 14 stores computer programs for various processing which will be described later. The RAM 16 is a storage area to be used when the CPU 12 executes various computer programs. A predetermined storage area in which information for various processing which will described later is to be stored, is allocated in the RAM 16. The CPU 12 executes or runs various computer programs stored in the program RAM 14 and controls the FAX apparatus 10. Accordingly, in the FAX apparatus 10, various processing are carried out, and various functions are realized.

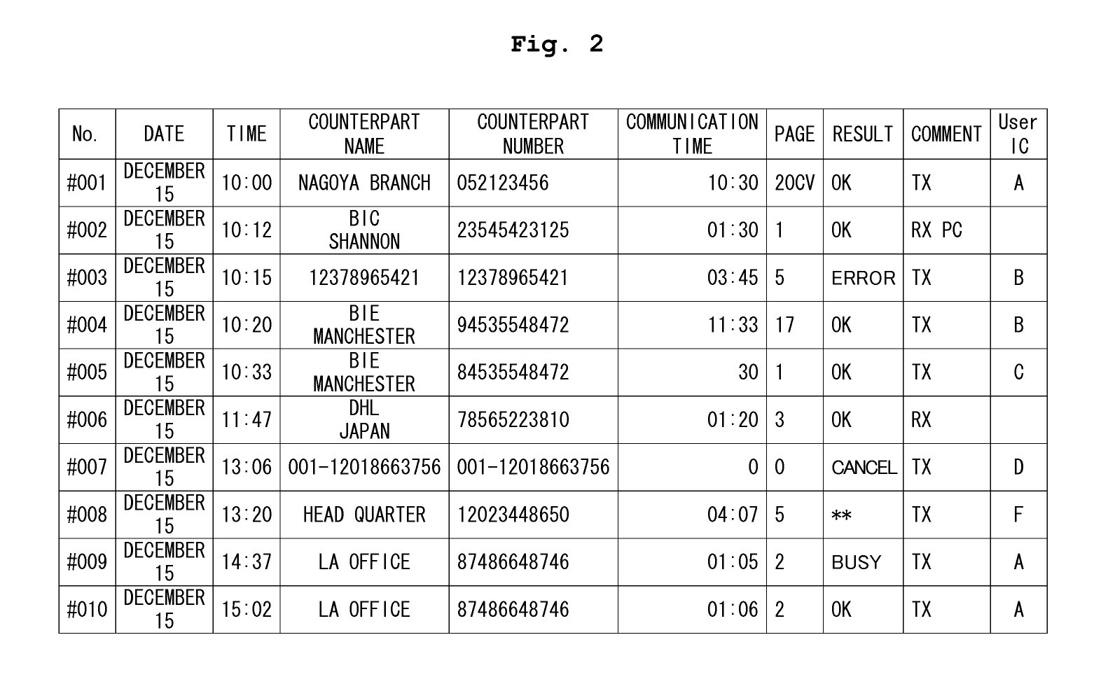

The flash ROM 18 is capable of storing various data. For instance, a communication record table of main-body side, in other words, a communication history table of main-body side, is stored in the flash ROM 18. The communication records of FAX communication carried out by the FAX apparatus 10 are stored in the communication record table of main-body side. Every time the FAX communication is carried out, a record is stored in the communication record table of main-body side as a communication record of the FAX communication carried out. As shown in FIG. 2, the communication record table of main-body side includes control items, such as No., date, time, remote name, remote number, communication time, page, result, comment, and user ID. Each control item is an item controlled even in a communication record of the conventional FAX apparatus. Therefore, description related to the control items will be omitted. The items ‘remote name’ and ‘remote number’ are information of the remote apparatus corresponding to a FAX number of the remote apparatus 50 in the FAX communication. When the item ‘comment’ is ‘TX’, it indicates that the FAX communication of that record was transmission, and when the item ‘comment’ is ‘RX’, it indicates that the FAX communication of that record was reception. Moreover, when the item ‘comment’ is ‘RX PC’, it indicates a so-called PC-FAX reception. The PC-FAX reception is a reception mode in which FAX data received by the PSTN I/F 32 of the FAX apparatus 10, without being printed by the printing section 22, is transferred from the network I/F 34 to the external apparatus 52 via the LAN 92, and received by the external apparatus 52. The item ‘user ID’, in a case in which the FAX transmission has been carried out, is user information for identifying the user who carried out the FAX transmission. The control items to be included in the communication record table of main-body side are not restricted necessarily to the abovementioned items, and arbitrary items may be set according to the requirement.

The scanning section 20 scans a document set on the FAX apparatus 10. The printing section 22, in a case in which FAX data is received, prints an image corresponding to the FAX data received, on a recording paper. The display section 24 is a display for displaying information. The operating section 26 includes a plurality of input keys. The user is capable of inputting various types of commands to the FAX apparatus 10 by operating the operating section 26. The timer section 28 has a clock function, and measures elapsing of time. The authentication section 30 is configured to authenticate the user of the FAX apparatus 10. At the time of authentication, the user takes closer or insert a terminal device such as an IC card to the authentication section 30. The user information is stored in the terminal device such as the IC card, and the authentication section 30 detects the user information from the terminal such as the IC card. In the FAX apparatus 10, the user is authenticated or identified based on the user information acquired by the authentication section 30. The user authentication may be carried out by a method different from the abovementioned method. The PSTN I/F 32 is connected to the PSTN 90, and carries out tranceiving of various signals and FAX data for the FAX communication. The PSTN I/F 32, concretely, includes a modem, and an NCU, that is short for Network Control Unit, or a semiconductor DAA, that is short for Data Access Arrangement modem. The network I/F 34 is connected to the LAN 92, and carries out data communication with the external apparatus.

<Fax Transmission Processing>

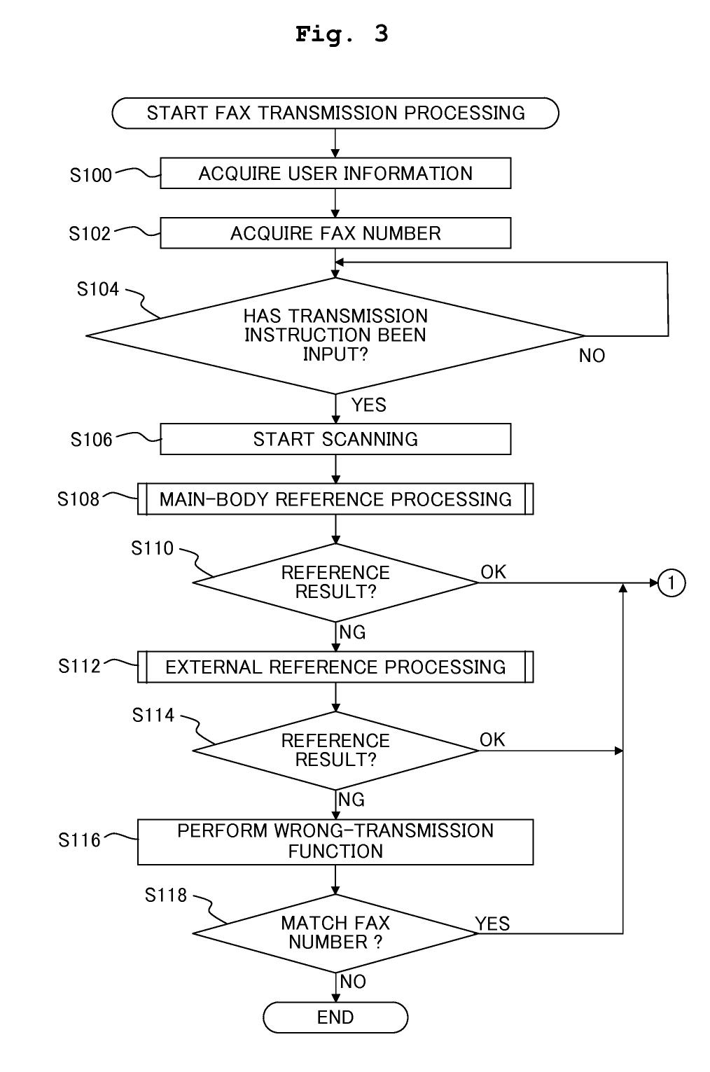

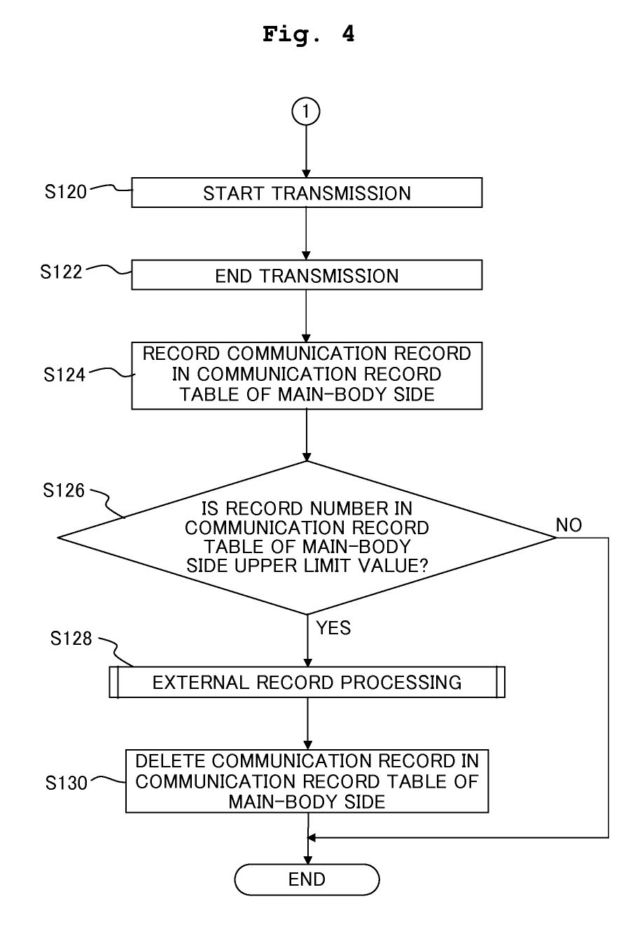

A FAX transmission processing will be described below by referring to FIGS. 3 and 4. At the time of start of the FAX transmission processing, a document to be transmitted is set on the FAX apparatus 10, and the user authentication is tried by the abovementioned method. When the user information has been detected by the authentication section 30, the CPU 12 starts the FAX transmission processing. The CPU 12 which has started the Fax transmission processing, acquires the user information which has been detected by the authentication section 30 (S100). The acquired user information is stored in a user information storage area allocated in the RAM 16. After the user authentication is carried out, the user operates the operating section 26 and inputs a facsimile number (hereinafter, called as ‘FAX number’) of the remote apparatus 50. The CPU 12 acquires the FAX number which has been input (S102). The aquired FAX number is stored in a FAX number storage area allocated in the RAM 16. The user who has input the FAX number operates the operating section 26, and inputs a transmission instruction for starting FAX transmission. The CPU 12 waits till the transmission instruction is input (S104: No). When the transmission instruction is input (S104: Yes), the CPU 12 controls the scanning section 20 to start the scanning of the document set on the FAX apparatus 10 (S106). The scanning section 20 starts the scanning of the document set on the FAX apparatus 10. Thereafter, the CPU 12 shifts the processing to step S108. At the time of the scanning of the document, the CPU 12 encodes the scanned image data corresponding to the scanned document into encoded data of a predetermined encoding type (such as MMR (Modified Modified Read), MR (Modified Read), or MH (Modified Huffman)), and stores the encoded data in the FAX data storage area allocated in the RAM 16. Eventually, FAX data in which image data corresponding to all the documents set on the FAX apparatus 10 is encoded is stored in the FAX data storage area. After the scanning by the scanning section 20 ends and, till the FAX data is stored in the FAX data storage area in the RAM 16, all the processing on or after step S108 may be carried out in parallel with the abovementioned scanning operation and a FAX data generating operation.

After letting the scanning section 20 start the scanning, the CPU 12 carries out the reference processing of main-body side (step S108). The reference processing of main-body side will be described later. After the reference processing of main-body side (step S108) is over, the CPU 12 judges whether a reference result for the communication record table of main-body side is ‘OK’ or ‘NG’. The reference result for the reference processing of main-body side is stored in a reference-result storage area allocated in the RAM 16, as it will be described later. When the reference result is ‘NG’ (S110: NG), the CPU 12 carries out a reference processing of external side (S112). The reference processing of external side will be described later. After the reference processing of external side (S112) is over, the CPU 12 judges whether a reference result for a table of communication record of external side is ‘OK’ or ‘NG’. The reference result for the reference processing of external side is stored in the reference result storage area in the RAM 16. When the reference result is ‘NG’ (S114: NG), CPU 12 carries out processing for a wrong transmission function (S116). The processing for wrong transmission function is a processing for making the user re-input the FAX number. Concretely, the CPU 12 controls the display section 24 such that a predetermined message is displayed on the display section 24. For instance, a message saying that there is a possibility that the FAX number which was input earlier is not a FAX number managed as a communication record, and may have been input wrongly, and giving an instruction to re-input the FAX number, is displayed on the display section 24. The CPU 12 acquires the re-input FAX number which has been re-input according to the displayed message (S116). The re-input FAX number is stored in the FAX number storage area in the RAM 16 similarly as the FAX number which has been acquired in the processing at step S102.

Next, the CPU 12 judges whether the FAX number of step S102 and the FAX number of step S116 are same or not. In the following, ‘the FAX number of step S102’ is the FAX number acquired in the processing at step S102 and stored in the FAX number storage area in the RAM 16, and ‘the FAX number of step S116’ is the FAX number acquired in the processing at step S116, and stored in the FAX number storage area in the RAM 16. When the FAX numbers do not match, the CPU 12 terminates the FAX transmission processing. In this case, the CPU 12 may control the display section 24 so that a message saying that the FAX transmission is cancelled as the FAX number input twice did not match, and a message saying that in a case of carrying out the FAX transmission, the user has to carry out the previous procedure once again, are displayed on the display 24.

When a reference result for the reference processing of main-body side is ‘OK’ (S110: OK), when a reference result for the reference processing of external side is ‘OK’ (S114: OK), or when the FAX numbers are judged to be the same in the processing at step S118 (S118: Yes), then the CPU 12 starts transmission of the FAX data (step S120, refer to FIG. 14). Concretely, the CPU 12 controls the PSTN I/F 32 such that the transmission of the FAX data starts. When a reference result in the processing at step S110 or at step S114 is ‘OK’ (steps S110, S114: OK), the destination of this transmission is ‘the FAX number of step S102’. When a judgment that the FAX numbers match is made in the processing at step S118 (S118: Yes), the destination of this transmission is ‘the FAX number of step S116’. Moreover, ‘the FAX number of step S116’ is same as ‘the FAX number of step S102’. Therefore, when the FAX numbers have matched in the processing at step S108 (S118: Yes), the destination of transmission is same as ‘the FAX number of step S102’. The FAX data to be transmitted is FAX data of which scanning is started at step S106 and which is stored in the FAX data storage area in the RAM 16. When all the data is transmitted via the PSTN I/F 32, the CPU 12 terminates the transmission (step S122). The procedures, which are carried out between the FAX apparatus 10 and the remote apparatus 50, and between the FAX apparatus 10 and the switch board 80, are carried out similarly as in the conventional FAX communication, in accordance with communication standards. Therefore, description related to this point will be omitted.

After the communication is over (step S122), the CPU 12 records communication record related to the FAX transmission in the processing at steps S120 and S122 in the communication record table of main-body side (step S124). In other words, as a communication record of this FAX transmission, the CPU 12 records a new communication record, in the communication record table of main-body side, including information associated with the items of the communication record table of main-body side shown in FIG. 2. Next, the CPU 12 judges whether or not the number of records stored in the communication record table of main-body side reaches an upper-limit value (step S126). The upper-limit value is a reference number which becomes a basis for the judgment in the processing at step S126, and is an upper limit of the number of records which can be stored in the communication record table of main-body side. Numbers such as ‘50’ or ‘10’ are exemplified as the upper-limit value. The upper-limit value can be set appropriately, for example, by taking into consideration a storage capacity of the flash ROM 18 which can be allocated for the communication record table of main-body side.

Assuming that the upper-limit value is ‘50’, and that a record of ‘No. #010’ shown in FIG. 2 is added in the processing at step S122. In this case, the number of records in the communication record table of main-body side is ‘10’, and the upper-limit value is lower than ‘50’. Then the CPU 12 judges that the number of records in the communication record table of main-body side does not reach the upper-limit value (S126: No), and the CPU 12 terminates the FAX transmission processing. Assuming that the upper-limit value is ‘10’, and that a record having an item of ‘NO. #010’ as shown in FIG. 2 is added in the processing at step S122. In this case, since the number of records in the communication record table of main-body side reaches the upper-limit value ‘10’, the CPU 12 judges that the number of records in the communication record table of main-body side has reached the upper-limit value (S126: Yes), and executes the external record processing (S126). The external recording processing will be described later. After terminating the external record processing (S126), the CPU 12 deletes the communication record recorded in the communication record table of main-body side (S130). After the processing at step S130, no record is recorded in the communication record table of main-body side. Thereafter, the CPU 12 terminates the FAX transmission processing.

<Main-Body Reference Processing>

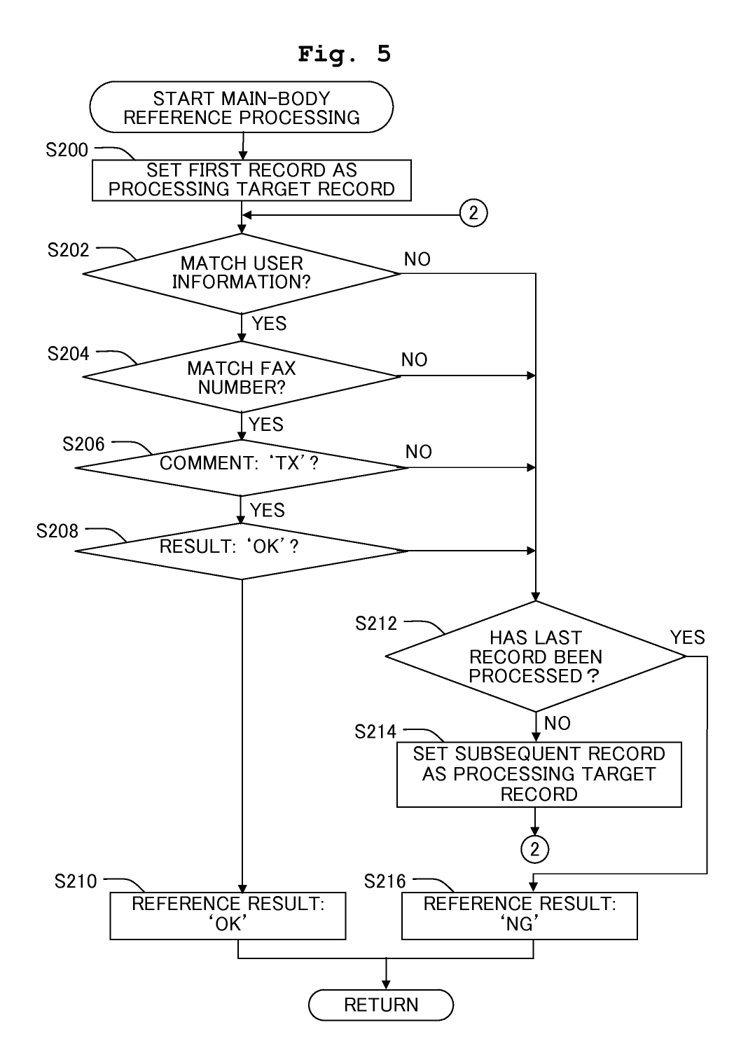

The main-body reference processing (S108) in FIG. 3 will be described below by referring to diagrams such as FIG. 5. The CPU 12 which has started the main-body reference processing, makes an access to the communication record table of main-body side stored in the flash ROM 18, and reads out in the RAM 16, and assigns the first record in the RAM 16 as a processing target (S200). At this time, the CPU 12 acquires or extracts information of each item associated with the first record. Consequently, a processing to be described later is carried out in order for records from the first record up to the last record. Based on FIG. 2, a record having item of ‘NO. #001’ is assigned to be the processing target.

Next, the CPU 12 judges whether or not a first user information and a second user information match, wherein the first information is acquired in the processing at step S100 in FIG. 3 and is stored in the user information storage area in RAM 16; and the second user information corresponds to the user ID in the record to be processed (hereinafter, referred to as the processing target record) (S202). When the user information do not match (S202: No), the CPU 12 shifts the processing to step S212. When the user information match (S202: Yes), the CPU 12 judges whether or not ‘the FAX number of step S102’ matches a FAX number of the remote in the processing target record (step S204). When the FAX numbers do not match (S204: No), the CPU 12 shifts the processing to step S212. When the FAX numbers match (S204: Yes), the CPU judges whether or not the item ‘comment’ in the processing target record is ‘TX’ indicating the FAX transmission (S206). When the item ‘comment’ in the processing target record is not ‘TX’ (S206: No), the CPU 12 shifts the processing to step S212. When the item ‘comment’ in the processing target record is ‘TX’ (S206: Yes), the CPU 12 judges whether or not the item ‘result’ in the processing target record is ‘OK’ indicating FAX transmission success (S208). When the item ‘result’ in the processing target record is either ‘error’ or ‘cancel’ and not ‘OK’ (S208: No), the CPU 12 shifts the processing to step S212. Here, ‘error’ stands for a transmission failed, and ‘cancel’ stands for transmission discontinued. When the result in the processing target record is ‘OK’ (S206: Yes), the CPU 12 sets ‘OK’ in a reference result which is a result of the main-body reference processing (S210). The reference result ‘OK’ which has been set is stored in the reference-result storage area in the RAM 16. The reference result ‘OK’ indicates that a record which satisfies all the judgment conditions in the processing of steps S202 to S208 has been recorded in the main-body table for communication record.

The CPU 31 judges whether or not the processing of the last record has been finished (S212). When the processing of the last record has not been finished (S212: No), the CPU 12 sets the subsequent record as the processing target record (S214). At this time, the CPU 12, similarly as in the step S200, acquires information of each item, which has been associated with in the processing target record. Thereafter, the CPU 12 returns to processing to step S202, and carries out processing from the processing at step S202 onward similarly as described above, according to the information acquired. When the main-body reference processing is carried out for all the records recorded in the communication record table of main-body side, and the processing of the last record has been finished (S212: Yes), the CPU 12 sets ‘NG’ in the reference result of the main-body reference processing (S216). The reference result ‘NG’ which has been set is stored in the reference-result storage area in the RAM 16. The reference result ‘NG’ indicates that a record which satisfies all the judgment conditions in the processing at steps S202 to S208, has not been recorded in the communication record table of main-body side. The CPU 12 terminates the main-body reference processing after the processing at step S210 or at step S216 has been executed, and the processing returns to step S110.

<External Reference Processing>

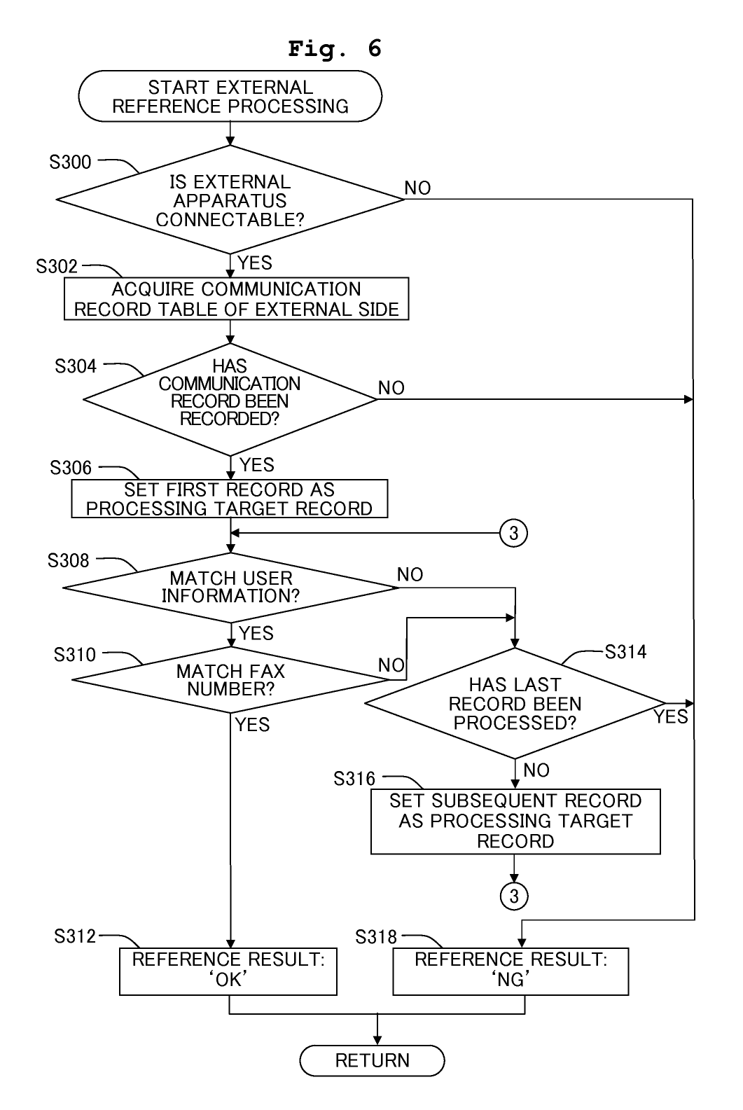

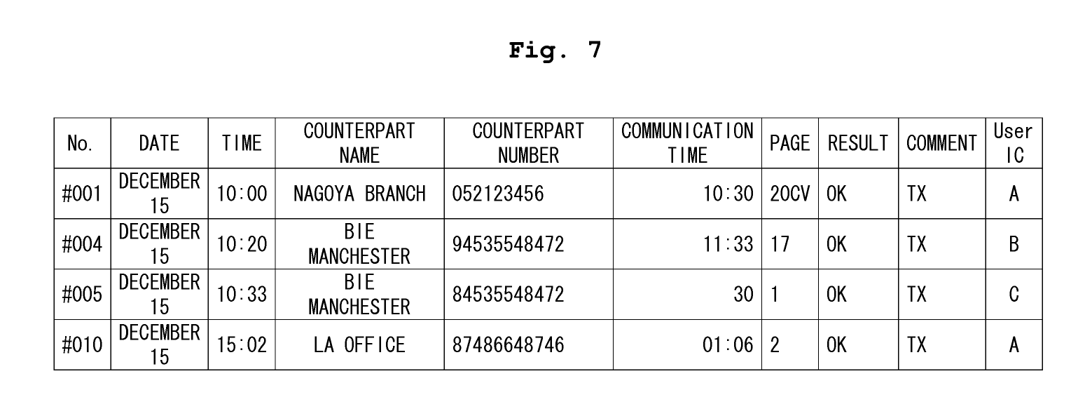

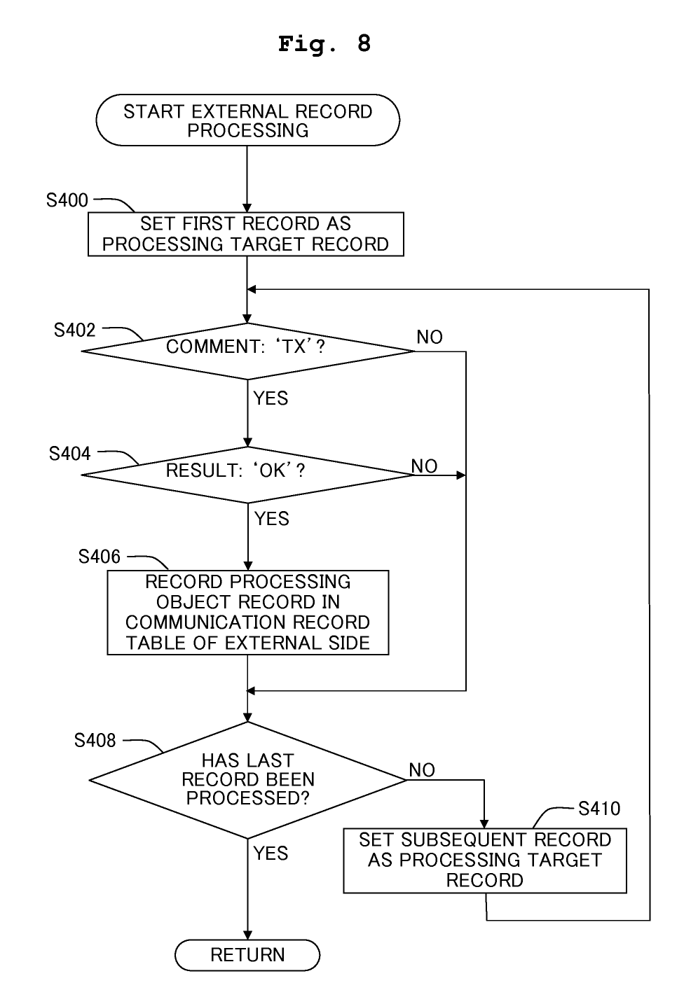

The external reference processing in FIG. 3 will be described below by referring to diagrams such as FIG. 6. The CPU 12 which has started the external reference processing judges whether the FAX apparatus 10 is data-communicably connected to the external apparatus 52 (S300). The processing at step S300 is carried out as described below. The CPU 12 controls the network I/F 34 to transmit a predetermined signal to a network which is constructed by the LAN 92. When there is no response transmitted from the external apparatus 52 at the network I/F 34, the CPU 12 judges that the FAX apparatus 10 is not data-communicably connected to the external apparatus 52 (S300: No). In this case, the CPU 12 shifts the processing to step S318. When the response from the external apparatus 52 is received by the network I/F 34, the CPU 12 judges that the FAX apparatus 10 is data-communicably connected to the external apparatus 52 (S300: Yes). In this case, the CPU 12 shifts the processing to step S302, and acquires the communication record table of external side. The CPU 12 makes a request to the external apparatus 52 for transmission of the communication record table of external side which has been stored in the external apparatus 52 (S302). The request made by the CPU 12 is transmitted from the network I/F 34 which is controlled by the CPU 12. Next, the CPU 12 controls the network I/F 34 to receive the communication record table of external side transmitted from the external apparatus 52 according to the request, and acquires the communication record table of external side. The received communication record table of external side is stored in the RAM 16. The communication record table of external side is a table as shown in FIG. 7, and includes items same as in the communication record table of main-body side (refer to FIG. 2). Recording of the communication records to the communication record table of external side is carried out through an external recording processing (S128 in FIG. 4, refer to FIG. 8 for details). Communication records, in which the item ‘result’ is ‘OK’ and the item ‘comment’ is ‘TX’, are recorded in the communication record table of external side (refer to processing at steps S402 to S406 in FIG. 8).

After carrying out the processing at step S302, the CPU 12 judges whether the communication record has been recorded in the acquired communication record table of external side (S304). In a case in which no record corresponding to the communication record has been recorded in the communication record table of external side, the CPU 12 judges that the communication record has not been recorded in the communication record table of external side acquired by the CPU 12. When at least one record have been recorded in the communication record table of external side, the CPU 12 judges that the communication record is recorded in the communication record table of external side acquired by the CPU 12. When the communication record is not recorded in the communication record table of external side (S304: No), the CPU 12 shifts the processing to step S318. When the communication record is recorded in the communication record table of external side (S304: Yes), the CPU 12 sets the first record recorded in the communication record table of external side stored in the RAM 16 as the processing target record (S306). In this case, the CPU 12 acquires or extracts information of each item associated with the first record. Consequently, processing which will be described later is carried out in order from the first record up to the last record. Based on FIG. 7, the record having an item of ‘No. #001’ is set to be a processing target record. Thereafter, the CPU 12 carries out the processing at steps S308 to S318 appropriately. Here, the processing at step S308 corresponds to the processing at step S202 in FIG. 5. Similarly, the processing at steps S310, S312, S314, S316, and S318 correspond to the processing at steps S204, S210, S212, S214, and S216 respectively. In other words, the processing at steps S308 to S318 is carried out similarly as the processing at steps S202, S204, S210, and S212 to S216. Therefore, the description of the processing at steps S308 to S318 will be omitted.

After carrying out the processing at step S312 or the processing at step S318, the CPU 12 terminates the external reference processing, and returns the processing to step S114 in FIG. 3. The reference result ‘OK’ of the external reference processing is set in the processing at step S312, and is stored in the reference-result storage area in the RAM 16. This reference result ‘OK’ of the external reference processing indicates that a record which satisfies all the judgment conditions in the processing at steps S308 to S310 has been recorded in the acquired communication record table of external side. The reference result ‘NG’ of the external reference processing is set in the processing at step S318 and is stored in the reference-result storage area in the RAM 16. This reference result ‘NG’ of the external reference processing indicates that a record which satisfies all the judgment conditions in the processing at steps S308 to S310 has not been recorded in the acquired communication record table of external side. In the external reference processing, processing corresponding to the processing at steps S206 and S208 have not been carried out. This is because only a record in which the item of ‘result’ is ‘OK’ and the item of ‘comment’ is ‘TX’ is recorded as a communication record in the communication record table of external side.

<External Record Processing>

The external record processing which is carried out in the processing at step S128 in FIG. 4 will be described below by referring to diagrams such as FIG. 8. The CPU 12 which has started the external record processing carries out processing at steps S400 to S404 appropriately. Here, the processing at step S400 corresponds to the processing at step S200. Similarly, the processing at steps S402 and S404 corresponds to the processing at steps S206 and S208 respectively. In other words, the processing at steps S400 to S404 is carried out similarly as the processing at steps S200, S206, and S208. Therefore, description of the processing at steps S400 to S404 will be omitted. In the external record processing, the processing at step S202 and the processing at step S204 in FIG. 5 are not carried out. This is because, only a record having the item of ‘result’ being ‘OK’ and the item of ‘comment’ being ‘TX’ is recorded as a communication record in the communication record table of external side.

When the CPU 12 judges that the item of ‘result’ is ‘OK’ (S404: Yes), the CPU 12 carries out processing for recording the processing target record, in which the item of ‘result’ is ‘OK’ and the item of ‘comment’ is ‘TX’, in the communication record table of external side stored in the external apparatus 52 (S406). Concretely, the CPU 12 controls the network I/F 34 to access to the external apparatus 52. More concretely, the CPU 12 controls the network I/F 34 to request to the external apparatus 52 to record the processing target record in the communication record table of external side. Along with this request or according to the reception of a response to the request from the external apparatus 52, the CPU 12 controls the network I/F 34 so that data which includes information of each processing item associated with the processing target record is transmitted to the external apparatus 52. The request and the data are transmitted via the network I/F 34 which is controlled by the CPU 12. Data including information of each item transmitted from the FAX apparatus 10 is received in the external apparatus 52, and a processing for recording this data in the communication record table of external side is carried out in the external apparatus 52. Accordingly, the processing target record is recorded in the communication record table of external side.

When the CPU 12 judges that the item of ‘comment’ is not ‘TX’ (S402: No), when the CPU 12 judges that the item of ‘result’ is not ‘OK’ (S404: No), or after the CPU 12 has carried out the processing at step S406, the CPU 12 judges whether the processing of the last record has been finished (S408). When the processing of the last record has not been finished (S408: No), the CPU 12 sets the subsequent record as the processing target record (S410). Here, the processing at step S408 corresponds to the processing at step S212 in FIG. 5, and the processing at step S410 corresponds to the processing at step S214 in FIG. 5. Since the processing at steps S408 and S410 is carried out similarly as the processing at steps S212 and S214 in FIG. 5, description of the processing at steps S408 and S410 will be omitted. In a case in which, the external record processing has been carried out for all the records which are recorded in the communication record table of main-body side, the CPU 12 judges that processing of the last record has been finished (S408: Yes), and terminates the external record processing. The processing returns to step S130 in FIG. 4.

The external record processing will be described below concretely by referring to the communication record table of main-body side shown in FIG. 2 and the communication record table of external side shown in FIG. 7. The CPU 12 which has started the external record processing sets the record having an item of ‘No. #001’ as the processing target record (S400). In the record having the item of ‘NO. #001’, the item of ‘result’ is ‘OK’ and the item of ‘comment’ is ‘TX’. Therefore, the CPU 12 selects Yes in both the processing at step S402 and step S404 (Yes at steps S402 and S404), and carries out the processing at step S406. Accordingly, the record having the item of ‘NO. #001’ is recorded as shown in FIG. 7, in the communication record table of external side stored in the external apparatus 52. Thereafter, the CPU 12 carries out the processing at step S408. Records having items other than ‘NO. #001’ are recorded in the communication record table of main-body side. Consequently, the CPU 12 sets a record having the item of ‘NO. #002’ as the processing target record (S410), and carries out the processing on or after step S402 once again.

In the record having an item of ‘NO. #002’, the item of ‘result’ is ‘OK’. However, the item of ‘comment’ is ‘RX PC’ and not ‘TX’. Consequently, the CPU 12 judges that the item of ‘comment’ is not ‘TX’ (S402: No), and shifts the processing to step S408. The communication record table of main-body side further includes other unprocessed records. The CPU 12 judges that the last record has not been processed (S408: No), and next, sets a record having an item of ‘NO. #003’ as the processing target record (S410), and once again carries out the processing on or after step S402. The item of ‘comment’ for the ‘NO. #003’ record is ‘TX’, but the item of ‘result’ is ‘error’, and not ‘OK’. Consequently, the CPU 12 judges that the item of ‘result’ is not ‘OK’ (S404: No), and the processing shifts to step S408. The processing at steps S408 and 410 is carried out repeatedly in order. In this case, for each of a record of ‘NO. #004 and a record of ‘NO. 005’ in the communication record table of main-body side shown in FIG. 2, the CPU 12 selects Yes for both in the processing at step S402 and step S404 (S402 and S404: Yes), and carries out the processing at step S406. Moreover, as shown in FIG. 7, each of these records is added in the communication record table of external side.

Thereafter, as the processing advances, a record ‘NO. #010’ is set as the processing target record (S410). Since the item of ‘result’ is ‘OK’ and the item of ‘comment’ is ‘TX’ for the record ‘NO. #010’, the CPU 12 selects Yes for both in the processing at step S402 and step S404 (S402 and S404: Yes), and carries out the processing at step S406. Accordingly, the record having an item of ‘NO. #010’ is added as shown in FIG. 7, in the communication record table of external side stored in the external apparatus 52. Thereafter, the CPU 12 executes the processing at step S408. At this point of time, since the record having the item of ‘NO. #010’ which is the last record, has already been processed, the CPU 12 judges that the last record has already been processed (S408: Yes), and terminates the external record processing.

<Effects Due to Embodiment>

The following effects can be achieved by the embodiment.

(1) In the FAX transmission processing (refer to FIG. 3 and FIG. 4), when the reference result in both the main-body reference processing (refer to step S108) and the external reference processing (refer to step S112) becomes ‘NG’ (refer to NG at steps S110 and S114), the processing at step S116 is carried out. Furthermore, the FAX transmission is started (refer to step S120) when the ‘FAX number of step 102’ and the ‘FAX number of step S116’ match (refer to Yes at step S118). Therefore, for instance, in a case of transmitting a FAX to the remote apparatus 50 to which no FAX has been transmitted so far, it is possible to prevent an occurrence of a situation in which, a wrong FAX number is input, and FAX data is transmitted to the wrong remote apparatus 50. Moreover, in a case in which a wrong transmission function (S116) is carried out, when the ‘FAX number of step S102’ and the ‘FAX number of step S116’ do not match (refer to No at step S118), the FAX transmission processing is terminated. It is possible to prevent the FAX data from being FAX transmitted with an uncertain FAX number input.

(2) In the main-body reference processing (step S108 in FIG. 3, refer to FIG. 5 for details), each of the records which have been recorded in the communication record table of main-body side is set as the processing target record. The processing target record is judged whether it corresponds to a communication record which has been successfully (OK) FAX transmitted (TX), from among the FAX transmissions which have already been carried out (refer to step S206 and step S208 in FIG. 5). Therefore, the judgment of whether the FAX number in the processing at step S102 is a FAX number to which the FAX transmission was succeeded in the past is made, and it is possible to detect favorably the wrong input of the FAX number. In the main-body reference processing, the judgment of whether the user information match is also made (refer to step S202), and the judgment in the processing at steps S206 and S208 is made for the FAX transmission which has already been carried out by the user in the past. Regarding the wrong input of the FAX number, since a judgment is performed based on the FAX transmission which user is aware of, the user can be rest assured that there is no wrong transmission of the FAX data.

(3) When the number of records in the communication record recorded in the communication record table of main-body side reaches the upper limit value (Yes at step S126 in FIG. 4), the external record processing is carried out (step S128 in FIG. 4, refer to FIG. 8 for details), and the communication record recorded in the communication record table of main-body side is recorded in the communication record table of external side. In doing so, from among the communication records recorded in the communication record table of main-body side, the record in which the item of ‘result’ is ‘OK’ and the item of ‘comment’ is ‘TX’ is recorded in the communication record table of external side (Yes at steps S402 and S404 in FIG. 8, refer to step S406). Therefore, it is possible to manage the communication record favorably. Moreover, it is possible to reduce the number of records recorded in the communication record table of external side. When the number of records is reduced, it is possible to shorten the time required for the external record processing, in particular the time required for the processing at step S406. In the external reference processing, since the records which are set as the processing target records are restricted to records in which the item of ‘result’ is ‘OK’ and the item of ‘comment’ is ‘TX’, it is possible to carry out the external reference processing efficiently. Apart from this, it is also possible to reduce a data capacity of the communication record table of external side, and it is possible to make effective use of the storage area of the external apparatus 52.

### Modified Embodiments

The following modifications may be made in the embodiment.

(1) In the abovementioned embodiment, in the FAX transmission processing (refer to FIGS. 3 and 4), the main-body reference processing (refer to step S108), the external reference processing (refer to step S112), and the external record processing (refer to step S128) are carried out. Out of these three processing, the external reference processing and the external record processing may be omitted. For instance, in a case of a FAX apparatus which does not have a data-communication function with the external apparatus 52, the external reference processing and the external record processing are not to be carried out. The communication record table of main-body side which is used in the main-body reference processing is stored in the flash ROM 18. However, the communication record table of main-body side may be stored in a storage device which is different from the flash ROM 18. In a case in which the FAX apparatus 10 includes a USB port for example, the communication record table of main-body side may be stored in a storage apparatus which is connected via USB port. Moreover, in a case in which the FAX apparatus 10 includes a memory card slot, the communication record table of main-body side may be stored in a memory card which is inserted in the memory card slot.

(2) In the abovementioned embodiment, in the main-body reference processing (step S108 in FIG. 3, refer to FIG. 5 for details), the CPU 12 judges whether the judgment result is ‘OK’ or ‘NG’, depending on matching of the user information (refer to step S202), matching of the FAX number (refer to step S204), whether the item of ‘comment’ is ‘TX’ (refer to step S206), and whether the item of ‘result’ is ‘OK’ (refer to step S208). Some of such judgment conditions may be omitted, added, or replaced. For instance, the matching of the user information may not be judged (omission of step S202). In this case, irrespective of whether the user information matches or not, when the ‘FAX number of step S102’ is same as the FAX number to which the FAX transmission was successful from the FAX apparatus 10, the reference result of the main-body reference processing becomes ‘OK’, and it is possible to prevent wrong input and wrong transmission based on the result of FAX transmission by the other user. Or, the CPU 12 may not judge whether the item of ‘result’ is ‘OK’ (omission of step S208). In a case in which a FAX number is input by operating a so-called address-book database or telephone directory database in which names of the remote apparatuses 50, that is remote names, and FAX numbers of the remote apparatuses 50 are associated, a judgment of matching of the remote name corresponding to the input FAX number and the remote name of the communication record main-body table may be carried out. In a case of adopting a judgment condition which includes the remote name, a judgment condition related to matching of the FAX number may be omitted. Or, the CPU 12 may judge whether the reference result of the main-body reference result becomes ‘OK’ or ‘NG’, based on whether the input FAX number is recorded in the communication record table of main-body side. Regarding the processing at steps S308 and S310 in the external reference processing (refer to FIG. 6), or the processing at steps S402 and S404 in the external record processing (refer to FIG. 8), some of the judgment conditions may be omitted, added, or replaced similarly as mentioned above. When the judgment conditions are lessened, it is possible to improve a processing speed of each of the main-body reference processing, the external reference processing, and the external record processing.

(3) In the embodiment described above, in the processing at step S302 in the external reference processing in FIG. 6, the communication record table of external side which is stored in the external apparatus 52 is acquired, and the CPU 12, in the FAX apparatus 10, carries out the processing at steps S304 to S310, step S314, and step S316. However, the present teachings are not restricted to such an arrangement. For instance, the external apparatus 52 may carry out the processing at steps S304 to S310, step S314, and step S316, and as a result of each of the processing, may judge whether the reference result is ‘OK’ or ‘NG’, and may transmit to the FAX apparatus 10. In this case, at a timing at which the processing at step S302 is carried out, the CPU 12 controls the network I/F 34 such that data which includes the FAX number which has been acquired at step S102 in FIG. 3 and the user information which has been acquired at step S100 in FIG. 3 is transmitted from the network I/F 34 to the external apparatus 52. In the external apparatus 52, each of the abovementioned processing is carried out according to the abovementioned data which has been transmitted, and thereafter, the reference result is transmitted to the FAX apparatus 10. The CPU 12 controls the network I/F 34 to receive the reference result. When the reference result received is ‘OK’, the CPU 12 carries out the processing at step S312, and when the reference result received is ‘NG’, the CPU 12 carries out the processing at step S318. It is possible to reduce a processing load on the FAX apparatus 10.

(4) In the abovementioned embodiment, in the main-body reference processing (refer to step S108) and the external reference processing (step S112), the ‘reference result’ becoming ‘OK’ was restricted to a record to be subjected to processing in which the item of ‘result’ is ‘OK’ and the item of ‘comment’ is ‘TX’. However, the present teachings are not necessarily restricted to such an arrangement. For instance, in the main-body reference processing (refer to step S108) and the external reference processing (S112), even when the item ‘comment’ is ‘RX’ or ‘RX PC’, and the item of ‘result’ is ‘OK’, the ‘reference result’ may be set to be ‘OK’. Even in such case, the remote apparatus can be considered to be a FAX apparatus. Therefore, even when it is considered to be a case in which no FAX transmission has been carried out even once, the remote apparatus can be said to have a high possibility of carrying out the FAX reception normally.

What is claimed is:

1. A facsimile apparatus which transmits facsimile data corresponding to a document to a remote apparatus via a communication line, comprising:
a scanning section which scans the document to generate the facsimile data;
an operating section through which a facsimile number of the remote apparatus is input;
a first communication section connected to the communication line;
a first communication control section which controls the first communication section;
a first storage section in which information of the remote apparatus corresponding to a facsimile number for a past facsimile transmission carried out by the facsimile apparatus, is stored;
a first judging section which judges whether or not information of the remote apparatus corresponding to a first facsimile number has been stored in the first storage section, under a condition that the first facsimile number is newly input via the operating section; and
a re-input section which controls the operating section to acquire once again the facsimile number of the remote apparatus to which the facsimile data is to be transmitted, as a second facsimile number, under a condition that the first judging section judges that the information of the remote apparatus corresponding to the first facsimile number is not stored in the first storage section,
wherein the first communication control section controls the first communication section to transmit the facsimile data to the remote apparatus of the first facsimile number, under a condition that the first judging section judges that the information of the remote apparatus corresponding to the first facsimile number is stored in the first storage section, and
the first communication control section controls the first communication section to transmit the facsimile data to the remote apparatus of the second facsimile number, under a condition that the second facsimile number is same as the first facsimile number.

2. The facsimile apparatus according to claim 1, wherein the information of the remote apparatus and a result of a past facsimile transmission carried out by the facsimile apparatus are associated with each other and stored in the first storage section,
the first judging section judges whether the information of the remote apparatus corresponding to the first facsimile number is stored in the first storage section, and whether a successful transmission result, which indicates a successful result in the past facsimile transmission and which is associated with the information of the remote apparatus corresponding to the first facsimile number, is stored in the first storage section, and
the re-input section controls the operating section to acquire once again the facsimile number of the remote apparatus to which the facsimile data is to be transmitted, under a condition that the first judging section judges that the information of the remote apparatus corresponding to the first facsimile number is not stored in the first storage section, or the successful transmission result is not stored in the first storage section.

3. The facsimile apparatus according to claim 2, wherein the first communication control section controls the first communication section to transmit the facsimile data to the remote apparatus of the first facsimile number, under a condition that the first judging section judges that the successful transmission result is stored in the first storage section.

4. The facsimile apparatus according to claim 1, further comprising:
a second communication section connected to a communication network which is different from the communication line and to which an external apparatus having a second storage section is connected; and
a second communication control section which controls the second communication section,
wherein information of the remote apparatus corresponding to a facsimile number of a past facsimile transmission carried out by the facsimile apparatus is stored in the second storage section,
the second communication control section controls the second communication section to access to the external apparatus, under a condition that the first judging section judges that the information of the remote apparatus corresponding to the first facsimile number is not stored in the first storage section,
the first judging section judges whether the information of the remote apparatus corresponding to the first facsimile number is stored in the second storage section,
the re-input section controls the operating section to acquire the facsimile number of the remote apparatus to which the facsimile data is to be transmitted, under a condition that the first judging section judges that the information of the remote apparatus corresponding to the first facsimile number is not stored in the first and second storage sections, and
the first communication control section controls the first communication section to transmit the facsimile data to the remote apparatus of the first facsimile number, under a condition that the first judging section judges that the information of the remote apparatus corresponding to the first facsimile number is stored in the first storage section or the second storage section.

5. The facsimile apparatus according to claim 4, further comprising:
a first recording section which adds, to the first storage section, a record of information of the remote apparatus corresponding to a facsimile number for a facsimile transmission which have already been carried out by the facsimile apparatus, under a condition that the facsimile transmission is carried out by the facsimile apparatus;
a second judging section which judges whether a number of the records of the information of the remote apparatus stored in the first storage section reaches a reference number; and
a second recording section which is configured to add, to the second storage section, a record of the information of the remote apparatus stored in the first storage section, via the second communication section which is controlled by the second communication control section, under a condition that the second judging section judges that the number of the records of the information of the remote apparatus stored in the first storage section reaches the reference number.

6. The facsimile apparatus according to claim 5, wherein a information of the remote apparatus and a result of a facsimile transmission which have already been carried out by the facsimile apparatus are associated with each other and stored in the first storage section,
under a condition that a facsimile transmission is carried out by the facsimile apparatus, the first recording section associates information of the remote apparatus corresponding to a facsimile number for the facsimile transmission which has been carried out with a transmission result of the facsimile transmission, and adds the associated record to the first storage section,
under a condition that the second judging section judges that the number of the records of the information of the remote apparatus stored in the first storage section reaches the reference number, the second recording section associates information of the remote apparatus, among the information of the remote apparatus stored in the first storage section, which has been associated with a transmission result showing a success of a facsimile transmission with a transmission result which indicates a success of a facsimile transmission, and adds the associated record, to the second storage section, via the second communication section which is controlled by the second communication control section,
the first judging section judges whether the information of the remote apparatus corresponding to the first facsimile number is stored in the first storage section, and whether the transmission result which indicates the success of facsimile transmission is stored in the first storage section upon being associated with the information of the remote apparatus corresponding to the first facsimile number,
the second communication control section controls the second communication section to access to the external apparatus, under a condition that the first judging section judges that the information of the remote apparatus corresponding to the first facsimile number is not stored in the first storage section, or the transmission result which indicates the success of facsimile transmission and which is associated with the information of the remote apparatus corresponding to the first facsimile number is not stored in the first storage section,
the re-input section controls the operating section to acquire the facsimile number of the remote apparatus, under a condition that the first judging section judges that the information of the remote apparatus corresponding to the first facsimile number is not stored in the first and second storage sections, or the transmission result which indicates the success of facsimile transmission is not stored in the first storage section upon being associated with the information of the remote apparatus corresponding to the first facsimile number, and
the first communication control section controls the first communication section to transmit the facsimile data to the remote apparatus of the first facsimile number, under a condition that the first judging section judges that the transmission result which indicates the success of facsimile transmission is stored in the first storage section upon being associated with the information of the remote apparatus corresponding to the first facsimile number, or that the information of the remote apparatus corresponding to the first facsimile number is stored in the second storage section.

7. The facsimile apparatus according to claim 1, further comprising an authentication section which detects user information corresponding to a user,
wherein information of the remote apparatus associated with user information is stored in the first storage section, and
the first judging section judges, for information of the remote apparatus associated with user information which has been detected newly by the authenticating section, whether the information of the remote apparatus corresponding to the first facsimile number is stored in the first storage section.
